(19) United States
(12) Patent Application Publication
(10) Pub. No.: US 2004/0244720 A1
(43) Pub. Date: Dec. 9, 2004

(54) Flavored dental crew

(76) Inventor: Tiandong Jia, Somerset, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/758,961

(22) Filed: Jan. 16, 2004

Related U.S. Application Data
(60) Provisional application No. 60/470,702, filed on May 15, 2003.

(51) Int. Cl. A01K 29/00

(52) U.S. Cl. 119/710

(57) ABSTRACT

A pet product such as a dental chew is made of animal hide that has been infused with flavor ingredients and one or more dental aids that promote the dental health of the pet. The dental aids promote calculus and plaque reduction, whiter teeth and healthier gums.

### RELATED APPLICATIONS

This application claims priority to provisional application Ser. No. 60/470,702, filed May 15, 2003 and incorporated herein by reference.

### FIELD OF INVENTION

This invention pertains to dental chews made from animal hide, particularly, cow hide, that is infused with flavor, color or one or more dentifrice materials selected to promote the dental health of the teeth and gum of a pet, such as a dog.

### DESCRIPTION OF THE PRIOR ART

Rawhide chews for dogs are typically made of animal hide, such as cow hide. The hide from tannery or other sources is processed to remove traces of meat and other undesirable residues. As part of this process, the hide is washed by water, delimed, degreased, bleached and washed a second time. The clean hide is dried.

The cleaned and dried hide is then cut into smaller sections or pieces, coated with a slurry containing various ingredients, including flavors and colors and then basted and dried in an oven a second time. The hide is soaked in the slurry without providing agitation or other means of accelerating the infusion process.

When pet chews this flavored product, the mechanical abrasive action cleans the pet's teeth. However, it has been found that mechanical abrasion by itself may not provide a sufficient prophylactic for effective dental care.

U.S. Pat. No. 5,618,518 discloses a chew product useful against the build-up of dental calculus on the teeth of animals contains an amount of sodium hexametaphosphate that is alleged to be effective to reduce the development of dental calculus. The chew product in one embodiment is prepared by soaking the product in an aqueous solution containing from about 0.5% to about 3.0% by weight sodium hexametaphosphate. Also disclosed in this patent are methods for preparing the novel chew product and for using the chew product containing sodium hexametaphosphate to reduce and/or prevent the build-up of dental calculus on the teeth of animals.

### SUMMARY OF THE INVENTION

A dental chew produced in accordance with this invention is made from animal hide, preferably cow hide, which is introduced into a bath. Importantly, the bath used to infuse the hide includes flavoring ingredients and dental aids that may include dentifrice ingredients, such as amylase, protease, dextranase, calcium peroxide, disodium EDTA, zinc, vitamin C, co-enzyme Q10, xylitol, or neem. The hide is cut into hide pieces and dried using a standard drying process.

The resulting product has a distinctive flavor and odor, which is attractive to the pet and it maintains its attractiveness until the product being consumed completely by the pet. The product also has one or more of the following beneficial effects when chewed by pet: it reduces calculus, it reduces plaque, it whitens teeth and it promotes healthy gums.

### DETAILED DESCRIPTION OF THE INVENTION

Typically, pet chews, including dog chews, are made from an animal hide that is cleaned, shaped and infused with a flavor and/or color. Conventional methods required two drying steps. The two patent applications identified above disclose methods for making a dog chews or dog rolls using a single drying process.

The subject invention further covers adding one or more dental aids as ingredient to the dog chew. As a result, when pet chews this novel product, in addition to mechanical abrasive action of teeth cleaning, the dental aid ingredients also provide reducing calculus, reducing plaque, whitening teeth and helping gum recovery. Moreover, releasing a dental aid directly on the pet teeth is more efficient then using other means. The resulting dental chew is more attractive to pets then prior art products. The product may be tailored for use for other animals, and even humans.

Some of the ingredients that may be added are listed below together with the respective benefits that they provide:

Enzyme mixtures (Dextranase, protease, amylase) and chelating agents (EDTA) are beneficial for calculus reduction/prevention.

Bactericides(Chlorhexidine, Triclosan, Xylitol, Fluoride, Neem) are beneficial for plaque reduction/prevention.

Bleaches (Peroxide, Glucose oxidase) are beneficial for teeth whitening.

Vitamin C, Co-enzyme Q10, and Periostat (Doxycycline hyclate) are beneficial because they assist in collage production, or reduction and assist in gum recovery.

Preferably, a dental chew produced in accordance with this invention is made from animal hide, such as cow hide. The hide obtained from a tannery or other sources and is treated with various chemical agents and washed to remove any meat and other undesirable materials.

The clean hide is then immersed in a bath containing flavor to enhance the taste and smell of the chew and make it more desirable and attractive to the pet, color to enhance its esthetic aspect and one or more dentrifice materials. While the hide is in the bath, the bath may be agitated to accelerate the rate of infusion of the required ingredients into the hide.

After infusion, the hide is removed from the bath and cut into pieces of any desired shape. A conventional rawhide drying process is used to dry the hide pieces.

In summary a dental chew is disclosed that includes a dental aid or dentrifice. The dental aid is selected so that as a pet chews the dental chew, the dental aid provides one or more of the following benefits: reduces calculus, reduces plaque, promotes whiter teeth and promotes healthier gums.

While the invention has been described with reference to several particular embodiments, it is to be understood that these embodiments are merely illustrative of the principles of the invention. Accordingly, the embodiments described in particular should be considered as exemplary, not limiting, with respect to the following claims.

I claim:

1. A dental chew comprising:
a body of animal hide, said body being infused with a flavor ingredient and a dental aid, said dental aid being selected to provide at least one of calculus reduction, plaque reduction, tooth whitening or gum recovery as a pet chews the body.

2. The dental chew of claim 1 wherein said dental aid is selected from the group consisting of dextranase, protese and amylase.

3. The dental chew of claim 1 wherein said dental aid is selected from the group consisting of chlorhexidine, triclosan, xylitol, fluoride and neem.

4. A pet chew comprising:
an animal hide piece having a predetermined shape and size; and
a coating disposed on said animal hide piece, said coating including a flavor and a dental aid selected from the group consisting of dental aids for providing at least one of calculus reduction, plaque reduction, tooth whitening and gum recovery as a pet chews the piece.

5. A method of making a dental chew comprising the steps of:
providing a clean hide;
infusing the clean hide with an ingredient including a flavor and a dental aid selected from the group consisting of dental aids for providing at least one of calculus reduction, plaque reduction, tooth whitening and gum recovery as a pet chews the piece;
cutting the hide to make hide pieces; and
drying the hide pieces to make dental chews.
